(19) United States
(12) Patent Application Publication
(10) Pub. No.: US 2022/0027178 A1
(43) Pub. Date: Jan. 27, 2022

(54) ALLOWING COMMAND SESSION FROM A GUEST OPERATING ENVIRONMENT

(71) Applicant: Unisys Corporation, Blue Bell, PA (US)

(72) Inventors: Charles Caldarale, Eagan, MN (US); Patrick Deziel, Eagan, MN (US); Tim Dick, Eagan, MN (US); Kevin Harris, Nashua, NH (US); Matthew Nuechtertein, Eagan, MN (US)

(21) Appl. No.: 16/938,929

(22) Filed: Jul. 25, 2020

(51) Int. Cl. G06F 9/455; G06F 9/451; G06F 21/53

(52) U.S. Cl. CPC G06F 9/45545; G06F 9/452; G06F 9/45558; G06F 2009/45595; G06F 21/53; G06F 2009/45587; G06F 9/45512

(57) ABSTRACT

The present disclosure relates generally to computer architecture and infrastructure for guest operating systems executing on a host operating system. A method of allowing command sessions in a guest operating system includes receiving, by a host operating system, a request to invoke a command session by a guest operating system; receiving, by the host operating system, a request to invoke a bash interceptor; and loading bash code into a secure sandbox on the host operating system.

### FIELD OF THE DISCLOSURE

The present invention relates generally to a guest operating system having control of the underlying hardware and software resources rather than a host operating system. In particular, the host operating system provides the management of the infrastructure but the guest operating system controls the infrastructure.

### BACKGROUND

Enterprises have highly demanding computing environments in terms of security, reliability and performance, requiring computing systems that are secure, adaptable, fast and reliable. This includes both enterprise-hosted computing systems as well as cloud computing system, and often requires integration across organizations and computing platforms within an enterprise. Such hosted systems may require use of various software that supports workloads executing on commodity Windows-based systems, Linus-based systems, and legacy systems that support robust mainframe-type reliability required for enterprise workloads. Such legacy enterprise systems often have different computing requirements as compared to workloads on commodity systems. Over time, commodity server systems have replaced mainframes but the demand for the mainframe operating system continues in particular for legacy systems. As such, an emulated system allows the mainframe operating system to run on top of a native operating system using an interface layer in between. However, the native operating system still manages and controls the resources and infrastructure of the computing system. Therefore, improvements are desirable.

### SUMMARY

The present invention relates generally to computer architecture and infrastructure for guest operating systems executing on a host operating system. More particularly, the present invention relates to methods and system for allowing a guest operating system to control the resources of a commodity server system. According to one embodiment, a method of allowing command sessions in a guest operating system includes receiving, by a host operating system, a request to invoke a command session by a guest operating system; receiving, by the host operating system, a request to invoke a bash interceptor; and loading bash code into a secure sandbox on the host operating system.

According to another embodiment, a computer program product for allowing command sessions in a guest operating system includes a non-transitory computer-readable medium comprising a set of instructions that when executed by a programmable computing device causes the computing device to implement a method for configuring a set of network devices, the method including receiving, by a host operating system, a request to invoke a command session by a guest operating system; receiving, by the host operating system, a request to invoke a bash interceptor; and loading bash code into a secure sandbox on the host operating system.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a schematic block diagram of a mainframe computing architecture, according to an example embodiment of the present disclosure.

FIG. 2 is a schematic block diagram of an emulated computing architecture, according to an example embodiment of the present disclosure.

FIG. 3 is a schematic block diagram of an emulated computing architecture, according to an example embodiment of the present disclosure.

FIG. 4 is a schematic block diagram of an emulated computing architecture where a host operating system controls and manages the computing resources, according to an example embodiment of the present disclosure.

FIG. 5 is a schematic block diagram of an emulated computing architecture where a guest operating system controls and manages the computing resources, according to an example embodiment of the present disclosure.

FIG. 6 is a schematic block diagram of an emulated computing architecture illustrating communication paths, according to an example embodiment of the present disclosure.

FIG. 7 is a schematic block diagram of an emulated computing architecture, according to an example embodiment of the present disclosure.

FIG. 8 is a schematic block diagram illustrating a sequence of call in an emulated computing architecture, according to an example embodiment of the present disclosure.

FIG. 9 is a file hierarchy of an emulated computing architecture, according to an example embodiment of the present disclosure

FIG. 10 is a flow diagram illustrating the creation of a secure sandbox, according to an example embodiment of the present disclosure.

FIG. 11 is a schematic block diagram of an emulated computing architecture illustrating a mechanism for block to stream conversion, according to an example embodiment of the present disclosure.

FIG. 12 is a schematic block diagram of an emulated computing architecture illustrating marshaling a guest to host, according to an example embodiment of the present disclosure.

FIG. 13 is a schematic block diagram of an emulated computing architecture illustrating a bash execution, according to an example embodiment of the present disclosure.

FIG. 14 is a schematic block diagram of an emulated computing architecture, according to an example embodiment of the present disclosure.

FIG. 15 is a schematic block diagram of an emulated computing architecture, according to an example embodiment of the present disclosure.

FIG. 16 is a schematic block diagram of an emulated computing architecture, according to an example embodiment of the present disclosure.

FIG. 17 is a schematic block diagram of an emulated computing architecture, according to an example embodiment of the present disclosure.

FIG. 18 a schematic a computer network, according to an example embodiment of the present disclosure.

FIG. 19 is a schematic block diagram of a computer, according to an example embodiment of the present disclosure.

FIG. 20 illustrates an example of the process hierarchy created in the Host OS 730 after several Native app processes have been initiated by NativeX.

### DETAILED DESCRIPTION

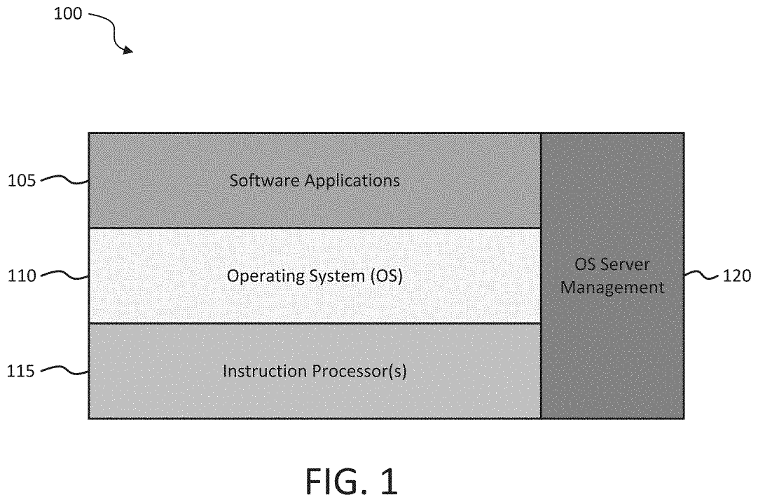

FIG. 1 shows a computing system 100 according to one example embodiment. The computing system 100 includes software applications 105, an operating system (OS) 110, instruction processors (IPs) 115 and OS server management 120. The software applications 105 require a large degree of data security and recoverability. The software applications 105 were typically supported by mainframe data processing systems. The software applications 105 may be configured for utility, transportation, finance, government and military installations and infrastructures. Such applications are generally supported by mainframe systems because mainframes provide a large degree of data redundancy, enhanced data recoverability features and sophisticated data security features. These mainframe systems were generally manufactured with proprietary CMOS chips. In one embodiment, the computing system 100 is a main frame data processing system. However, many mainframe systems have been replaced with commodity server systems using an emulated mainframe OS allowing legacy software systems to remain viable. Such emulated systems require an interface layer between the mainframe OS and the commodity server system.

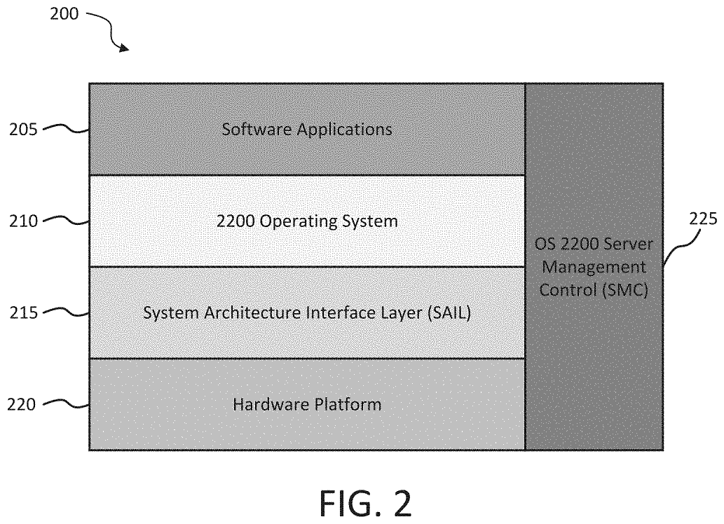

FIG. 2 shows an example of an OS that may be implemented in an emulated processing environment 200 on commodity servers rather than a mainframe as in FIG. 1. The emulated environment includes software applications 205, an emulated operating system 210 (or Guest OS), an interface layer 215, a hardware platform 220 (having a native OS) and server management control 225. The hardware platform can be a commodity server system. In this example, the emulated OS is an OS 2200 operating system 210 from UNISYS® Corp. A system architecture interface layer (SAIL) 215 is the kernel structure between the OS 210 and the hardware platform 220. The interface layer 215 is what allows the OS 2200 to run on a commodity server system.

The SAIL package includes the following components: SAIL Kernel—SUSE Linux Enterprise Server distribution with open source modifications; System Control (SysCon)—the glue that creates and controls the instruction processor emulators; 2200 Instruction Processor emulated—based on 2200 ASA-00108 architecture; Network emulators; and Standard Channel Input/output processor (IOP) drivers. The hardware platform 220 is, in one example, a DELL® server with associated storage input/output processors, host bus adapter, host adapters and network interface cards. Embodiments of the present invention are not limited to any particular host system or hardware platform but may instead be adapted for application with any underlying system.

The OS 2200 server management control (SMC) 225 monitors the performance at all levels of the computing system 200, including the software applications 205, 2200 OS 210, SAIL 215, and the hardware platform 220.

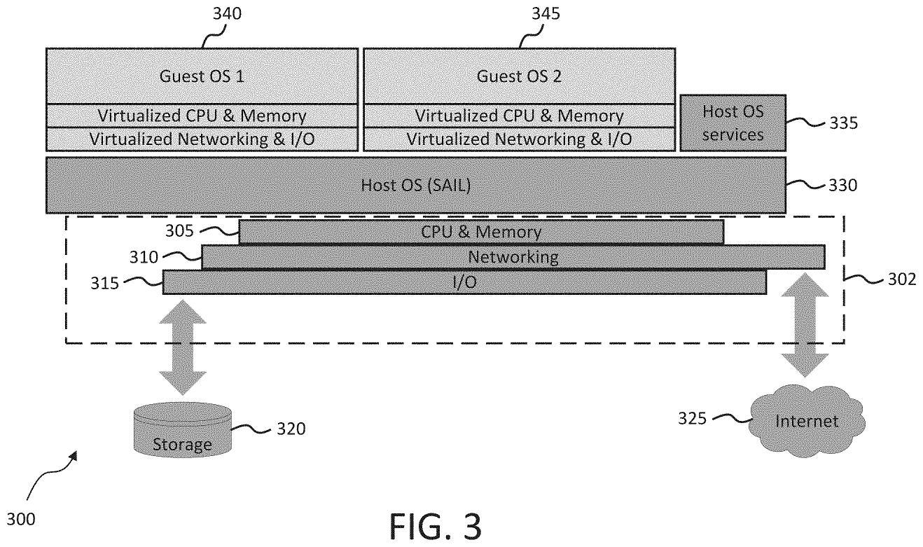

Referring to FIG. 3, an example computing system 300 is shown. An underlying commodity hardware platform 302 includes a CPU and Memory 305, networking 310 capabilities, and I/O 315 capabilities. The hardware platform 302 is also connected to storage 320 and to the Internet 325. A Host OS 330, such as SAIL, runs on the commodity hardware platform 302 along with Host OS services 335. Running on top of the Host OS 330 is a first Guest OS 340 and a second Guest OS 345. The first Guest OS 340 may be an OS 2200 operating environment while the second Guest OS 345 is running in a commodity operating system. This is referred to as a hybrid system since the first Guest OS 340 and the second Guest OS 345 are different environments but both are running on a common commodity hardware platform 302. Unisys® Dorado Native Execution (NativeX) provides a mechanism for hybrid execution between an application or service running in the OS 2200 operating system and an application or service running in a commodity operating system—all on the same server hardware. Each Guest OS 340, 345 has virtualized CPU, Memory, Networking and I/O such that it is executing in an emulated environment within the Host OS 330. In this scenario, the Host OS 330 controls and manages the underlying infrastructure 302. The Guest OS 340, 345 make requests to the Host OS 330 for hardware and software resources. The Host OS 330 manages those resources because the Guest OS 340, 345 does not have access to them.

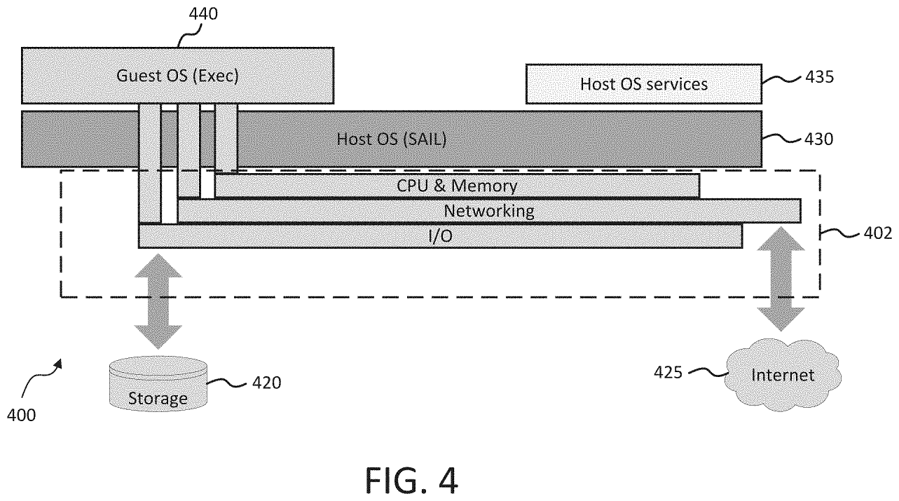

Referring to FIG. 4, an example computing system 400 is shown. A Host OS 430 and Host OS services 435 execute on an underlaying hardware platform 402 connected to storage 420 and the Internet 425. A single Guest OS 440 is also executing. In this embodiment, the Guest OS 440 can take control of the hardware and software resources of the hardware platform 402 and manage them as if they are local to the Guest OS 440. The Host OS 430 provides the management for the infrastructure services 435, such as network driver software and HBA (storage) driver software, along with providing higher level services such as a secure sandbox management. However, the operation of those Host OS services 435 is directed by the Guest OS 440 rather than the Host OS 430. As such, the Guest OS 440 controls and manages the underlying infrastructure.

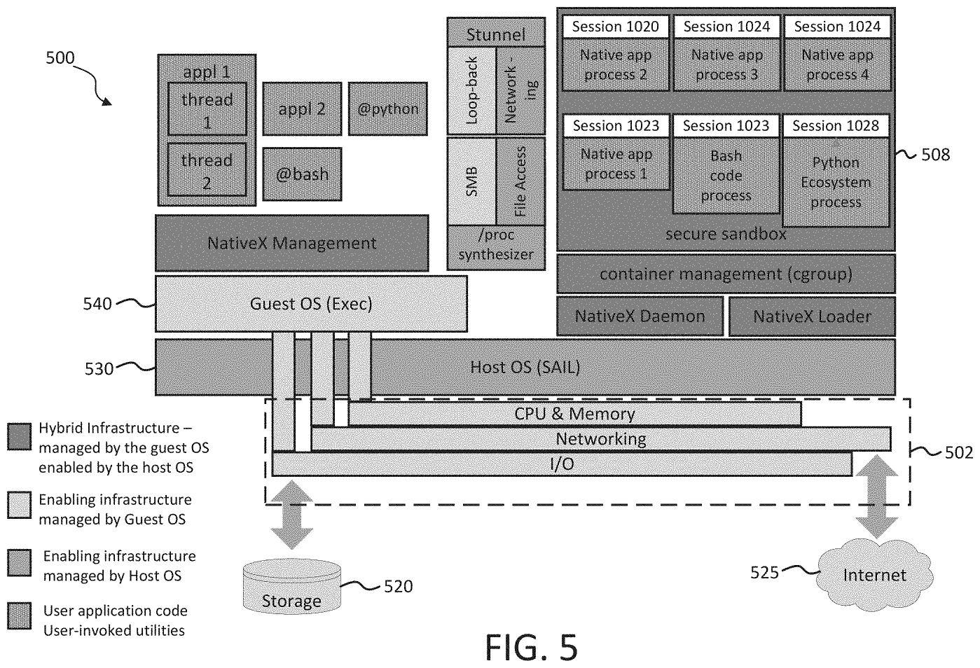

FIG. 5 illustrates a more detailed view of the overall architecture of FIG. 4. A secure sandbox 508 provide an execution environment for a service. A Host OS 530 creates the secure sandbox 508 as an isolated execution environment for the service, isolated from other secure sandboxes and from execution threads in the Host OS 530. These secure sandboxes 508 are also referred to as containers. In the NativeX system, a user utility or application executing on the Guest OS 540 wants to see any utility or application executing on the Host OS 530 as if it were executing natively in the Guest OS 530 itself. Thus, the boxes on the left above the Guest OS 540 (running on the Guest OS 540) correspond to the boxes on the right in the secure sandbox 508 (running on the Host OS 530). The boxes on the right are executing in the secure sandbox 508 but appear to the user on the left as native to the Guest OS 540. All of the boxes are running natively in the Host OS 530 but are controlled by the Guest OS 540 (i.e. started, stopped, controlled or monitored). By running in the Host OS 540, they can take certain native actions, but certain actions are not allowed so that the Guest OS 530 can control. An important difference between the generalized containers and the NativeX solution is that a NativeX sandbox constrains a service's visibility to services significantly and enforces a unique authentication and authorization mechanism.

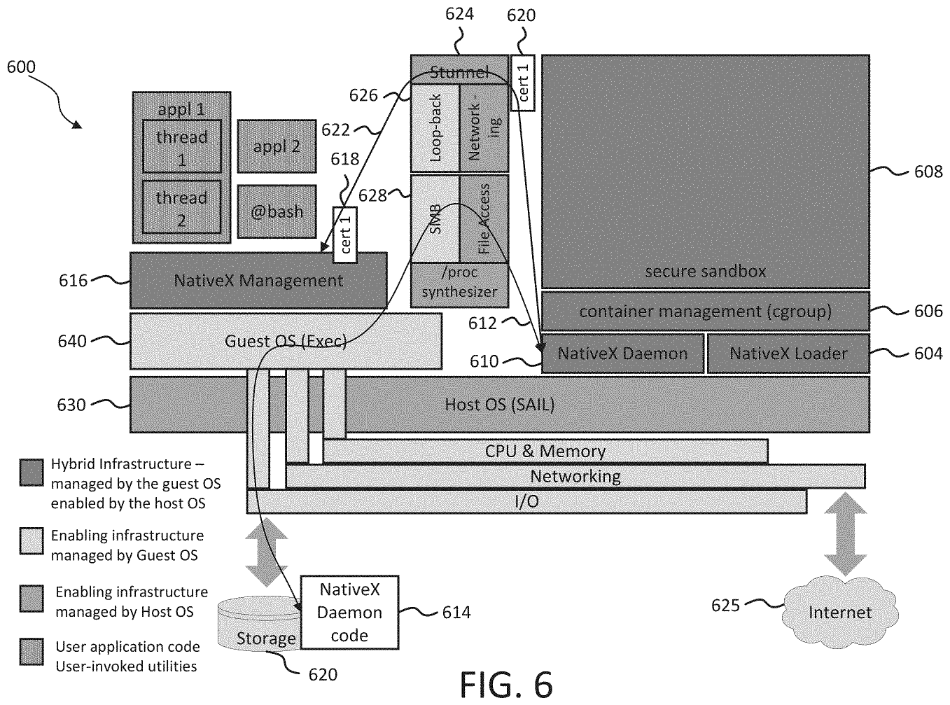

Referring to FIG. 6, a NativeX Loader 604 performs a standard boot load function in the Host OS 630. When the Host OS 630 begins execution, the NativeX Loader 604 automatically gets initiated. The primary function of the NativeX Loader 604 is to initiate execution of the NativeX Daemon 610, using standard Host OS 630 functionality.

The NativeX Loader 604 includes configuration information to access a secure tunnel 624 (“Stunnel”) to create an encrypted communication path between the Guest OS 640 and the Host OS 630. The NativeX Loader 604 attaches to the Stunnel 624 and waits for a signal from NativeX Management 616 executing on the Guest OS 630. When the NativeX Loader 604 on the Host OS 630 is activated, it first creates a self-signed certificate 618 and stores it into the Loopback Networking 626 system, which persists at 620. The NativeX Management 616 then sends a message to the NativeX Loader 604 to load the NativeX Daemon code 614 from the Guest OS 640 controlled storage 625 via path 612 and using a Host OS 630 utility, such as systemd, to initiate its execution as NativeX Daemon 610. The NativeX Daemon 610 creates a cleartext communication path between the NativeX Daemon 610 and the NativeX Management 616 through Loopback Networking 626. The NativeX Daemon 610 then uses the certificate 620 to establish a secure, encrypted path 622 between it and the NativeX Management 616.

Next, the NativeX Daemon 610 creates the secure sandbox 608 within which all services requested by users in the Guest OS 640 execute. When creating the secure sandbox 608 in the Host OS 630, the NativeX Daemon 610 creates the secure sandbox 608 to have its attributes constrained in such a way that any process executing in the secure sandbox 608 appears to be executing as an extension of the Guest OS 640 environment. The NativeX Daemon 610 continues to execute until one of these situations occurs: NativeX Management 616 terminates either by error or by operator action; the Guest OS 640 terminates either by error or by operator action; or NativeX Management 616 sends a signal to NativeX Daemon 610 to terminate execution. When any of these situations occur, NativeX Daemon 610 receives a signal to terminate all processes executing in the secure sandbox 608, release any resources held by the processes, and terminate its own execution.

The secure sandbox 608 may not be an actual construct in the Host OS 630 environment. In some environments, it can exist as a “slice definition” in the Host OS 630, whereby any process initiated using that slice definition inherits the attributes and constraints of the slice. An important attribute of each slice is that it can be isolated from other slices such that each slice cannot read or write into each other's memory, control structures, etc. Each time the NativeX Daemon 610 starts or restarts, it recreates (overwrites) the secure sandbox/slice definition. It is a convenient abstraction to describe the slice/secure sandbox/container as a “container” in the standard sense of the word whereby any process executing “in the container” inherits the properties and constraints of the container. This abstraction and nomenclature are reinforced by the names and functions of other parts of the infrastructure such as the container management cgroup mechanisms.

The NativeX Daemon 610 creates the NativeX secure sandbox 608 with this set of constraints:
1. The secure sandbox 608 has a defined maximum memory size and a specific placement in memory.
2. The secure sandbox 608 has a specific set of CPUs upon which it may execute.
3. The secure sandbox 608 connects to storage 625 only through the Guest OS 640. It cannot access local or virtualized storage in the Host OS 630 as a typical container might.
4. The secure sandbox 608 connects to networking only through specific ports in the Host OS 630. It does not have general access to the Host OS 640 networking and cannot execute any network control functions.
5. Traditional Host OS 630 shell commands that need to activate privileged behavior, such as logging into an account named root, or using the su or sudo commands in bash, are not functional in the Nativex secure sandbox 608.
6. The NativeX secure sandbox 608 denies permission to see, modify, or delete files in the standard Host OS 630 directories, including /bin, /dev, /etc, /home, /lib64, /sbin, /usr, or /var.
7. The NativeX secure sandbox 608 provides each user with a subdirectory under /home, which is visible to other users, but whose contents are not accessible to any other NativeX session. Each NativeX session is also provided a subdirectory in the /tmp tree and can create, modify, and delete files there, but, unlike /home, files in /tmp are visible and accessible to other users.
8. The mount and unmount commands support mounting and unmounting devices and file systems not provided in the NativeX secure sandbox 608. The NativeX secure sandbox 608 provides the /dev/null, /dev/random, /dev/tty, and /dev/urandom devices as a convenience for processes, with their normal semantics. The mount and unmount commands may be used under SMB File Access 628 in the Guest OS 640, with appropriate privileges. Some utilities and programs attempt to provide a user prompt, such as a password request by opening /dev/tty, fail for this reason. Examples are sftp and ssh.
9. Each process executing in the NativeX secure sandbox 608 can perform I/O only through the SMB File Access 628, reading and writing files owned and managed under the Guest OS 640 file system.
10. The Host OS 630 may provide a set of features to allow processes to share memory for communication and performance. Attempting to use any of these features in a process running in the NativeX secure sandbox 608 will fail.
11. The NativeX secure sandbox 608 is implemented using the namespaces and control groups (cgroups) features of the Host OS 630, and these features cannot be used by processes executing in a NativeX secure sandbox 608.

The NativeX secure sandboxes 608 executes within the Host OS 630. However, due to the containment, aspects of the Host OS 630 system are not available to processes executing within the NativeX sandbox 608, including the uptime command, the utmp utility, the ps utility and the gdb utility. Processes running in the NativeX secure sandbox 608 are constrained with respect to system resources. Some resource limits pertain to individual active processes executing in the NativeX sandbox 608, while others pertain to the aggregate of all processes executing in the NativeX sandbox 608 at a specific time. When a resource request exceeds one of these limits, the relevant low-level system service call will return a failure status, which will sometimes become visible to the user as a failure within the running process, depending on the specific programming choices in that specific process. The global resource limitations imposed on all the aggregate of all processes executing in the NativeX sandbox 608 include number of simultaneously active processes, amount of system CPU usage available to processes, amount of working system memory available, number of simultaneously active user tasks or threads, core file size, maximum file size, number of pending signals, maximum amount of locked memory, pipe buffer size and message queue size and stack size. The normal limits for Guest OS 640 files are applied by the SMB file Access 628 mechanism. The resource limitations imposed by NativeX on each process executing in the NativeX sandbox 608 includes an accumulated CPU time from all tasks running on all cores and amount of working system memory available.

The final action of the NativeX Daemon 610 is to create a User ID (UID)/Group ID (GID) pool and pool management control structure. Unix-like operating systems identify a user by a value called a user identifier, often abbreviated to UID. The UID, along with the group identifier (GID) and other access control criteria, is used to determine which system resources a user can access. For NativeX processes executing in the Host OS 630 environment, the UID capabilities are constrained. The NativeX Daemon 610 creates and manages the UIDs and GIDs as UID/GID pairs. The pool of UIDs and GIDs are returned to the Host OS 630 when the NativeX Daemon 610 stops execution.

When a Guest OS 640 user invokes a process to execute in the NativeX environment in the Host OS 630 environment (in the secure sandbox), the NativeX Daemon 610 chooses a UID/GID pair from the pool and associates it with the Guest OS 640 user credential. When the NativeX Daemon 610 initiates the native process, it uses a Host OS 630 service to associate the UID/GID with the process to be initiated. If the Guest OS 640 user makes multiple invocations, through multiple execution threads, from different interactive sessions, from different Guest OS 640 initiated middleware, or from different user initiated background services, the NativeX Daemon 610 makes the association between the Guest OS 640 user credentials and the same, selected UID/GID pair. As a result, all services executing in NativeX on behalf of a Guest OS 640 user have the same UID/GID pair in the Host OS 630 environment, and thus the same credentials for accessing subsidiary services from either the Host OS 640 environment or the Guest OS 630 environment. When all services executing in NativeX in the Host OS 630 environment complete, the UID/GID pair is returned to the pool.

In a hybrid execution environment, a service executing in the secure sandbox 608 on the Host OS 630 must have the same credentials as a corresponding service, executing in the Guest OS 640, which initiated the secure sandbox service. This allows the Guest OS 640 to treat the service executing on the Host OS 630 as an extension of the Guest OS 640 and enforce the same authentication and authorization rules irrespective of the service execution environment choice. The Host OS 630 typically enforces credentials and provides authenticated access to only its resources. But, in the present disclosure, the Guest OS 640 operating within the Host OS 630 enforces credentials and authenticates access to resources within the Guest OS 640.

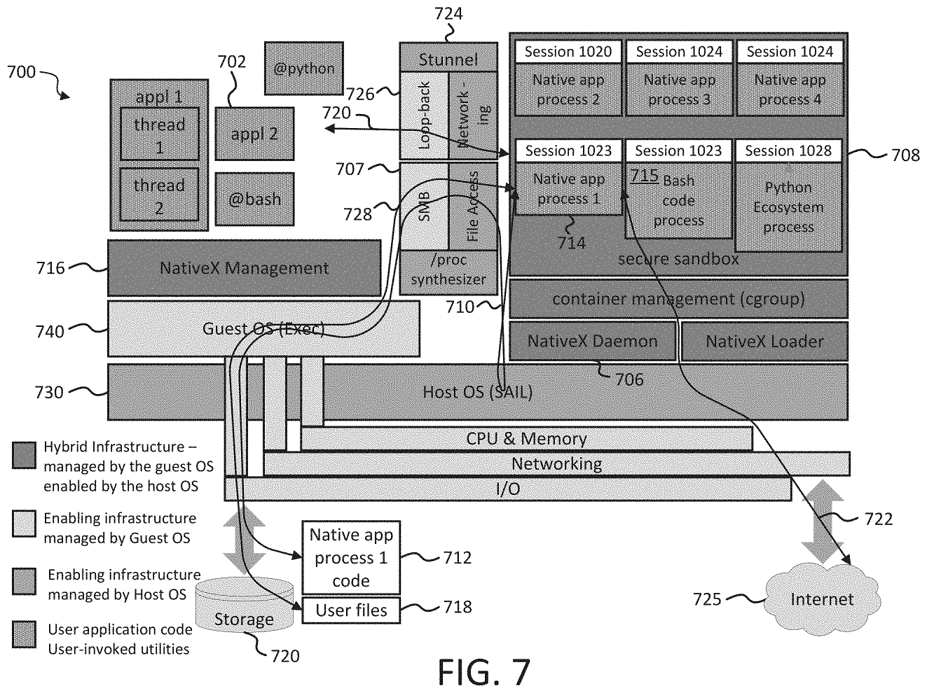

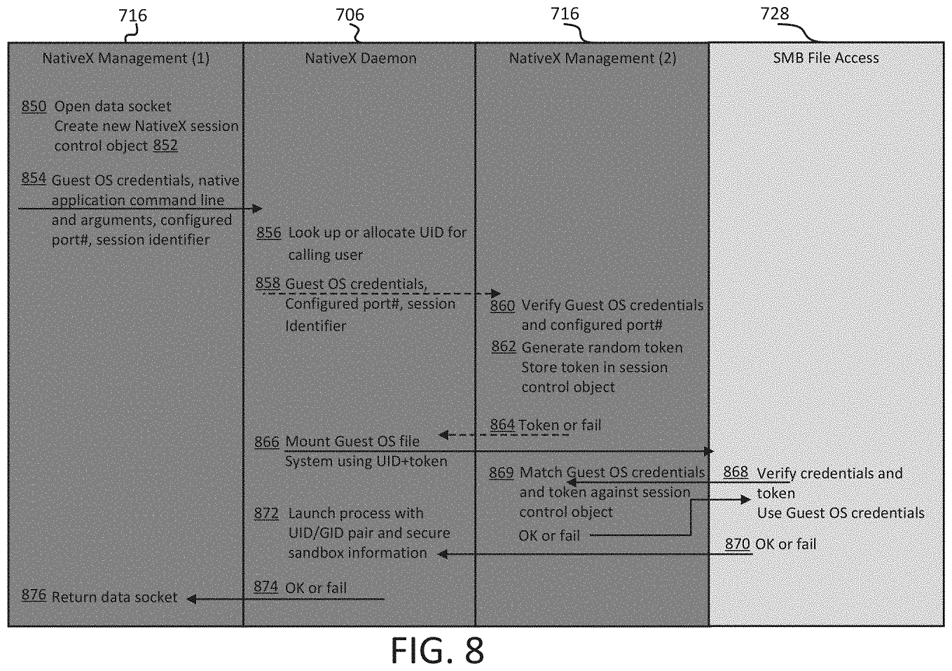

Referring to FIG. 7, when a Guest OS 740 based service such as appl 2 702 requests a service such as Native process 1 714 to be created in secure sandbox 708, the NativeX Management 716 uses the mechanism described in FIG. 8 to initiate the execution. NativeX Management 716 signals the NativeX Daemon 706 to execute the FIG. 8 mechanism and use the Host OS 730 process initiation mechanism to read the Native app process 1 code 712 from the Guest OS 740 file system and initiate its execution as Native app process 1 714. During its execution, when the Native process 1 714 requests file I/O to any user file in the Guest OS 740 environment, it uses path 716, through SMB File Access 728 created during the FIG. 8 processing. The Native app process 1 714 has exactly the same file access rights in the Guest OS 740 environment as the user associated with appl 2 702.

During its execution, when the Native process 1 714 requests network access, it can use Loopback Networking 726 via path 720 to communicate with other applications executing in the Guest OS 740 environment. It can also go directly through the Host OS 730 to other network services via path 722. Both access methods may be constrained by secure sandbox 708 rules. For example, the Native app process 1 714 was created on behalf of appl 2 702. In the event that appl 2 702 must terminate execution for some reason e.g., application end-of-execution, application abort, user-initiated termination request, operator-initiated termination, etc., the guest OS 740 must terminate and clean up all local and remote services associated with appl 2 702, including: terminate any outstanding I/O requests from the secure sandbox 708 in path 720 to user files 718; terminate and close any network communication occurring via path 720 or path 722; terminate the native process 1 714, and release the cpu, memory, and other resources associated with the process; if native process 1 714 is the last process associated with a NativeX session e.g., session 1023, unmount the file access path 716 in the Host OS 740 file system, terminate appl 2 702 and release cpu and memory associated with it. From the Guest OS 730 viewpoint, native app process 1 714 in secure sandbox 708, and appl 2 702 are a single, atomic unit of work under management by the Guest OS 740.

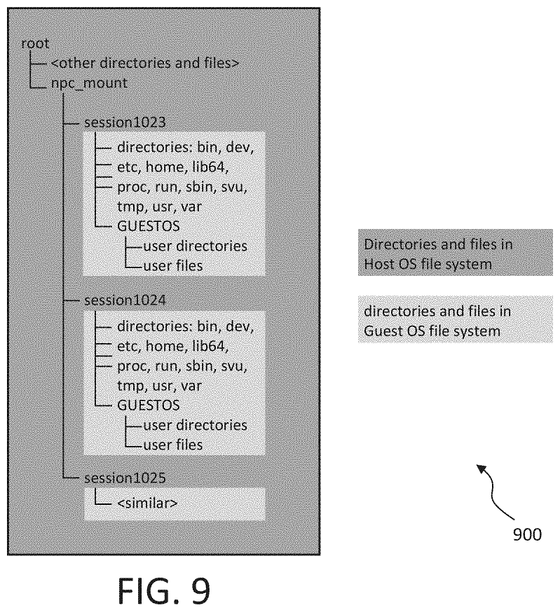

Referring to FIG. 8, 4 “swim lanes” are illustrated to show the sequence of calls across the components, to effect the processing including NativeX Management 1 716, NativeX Daemon 706, NativeX Management 2 716, and SMB File Access 728. The calls indicated by the solid line are across the standard Loopback Networking 726, while the calls indicated by dashed line which are across the secure, encrypted Stunnel 724. When a Guest OS-based service such as appl 2 702 requests a service such as Native process 1 714 to be created in secure sandbox 708, it initiates this sequence of processing:
850: The NativeX Management 716 opens a data socket to NativeX Daemon 706 using standard Loopback Networking 726. It creates a new NativeX process control object and persists it internally.
854: NativeX Management (1) 716 calls the NativeX Daemon 706 passing the Guest OS 740 user credentials, the call line and arguments from appl 2 702 to pass to Native process 1 714, the configured port number for the socket connection, and the session identifier. The Guest OS 740 user credentials include userid, account number, and project id, all of which are freely available to other Guest OS 740 applications and users. The Guest OS 740 user password is never sent across the NativeX infrastructure; the Guest OS 740 user password is not available to the NativeX infrastructure, nor is it needed.
856: The NativeX Daemon 706 looks in the User ID (UID)/Group ID (GID) pool management structure described above to find a match between the received Guest OS 740 credentials and an already-assigned UID/GID pair for those credentials. If a match exists, the NativeX Daemon 706 associates the new request with the existing session e.g., session 1023 previously associated with Bash code process 715. If no match exists, the NativeX Daemon 706 allocates a new UID/GID pair from the pool and creates a new session.
858: The NativeX Daemon 706 calls NativeX Management (2) 716 via the secure, encrypted Stunnel 724, passing the Guest OS 740 credentials and configured port number previously received from NativeX Management (1) 716.
860: NativeX Management (2) 716 verifies the Guest OS 740 credentials and configured port number received from the NativeX Daemon 706 across the secure, encrypted Stunnel 724 on call 858 match the Guest OS 740 credentials and configured port number sent to the NativeX Daemon 810 across the clear text channel on call 854.
862: Generate a random 128 bit token to act as a unique identifier for this session. Store the token in the session control object for this session. Making the callback 858 on the secure Stunnel 724 eliminates man-in-the-middle attacks and interception of the credential and token.
864: If no error occurred in the validation or other processing, return the token to the NativeX Daemon 706.
866: If an error is returned in 864 terminate processing. Otherwise, use the pre-existing SMB File Access 828 mechanism to mount( ) the Guest OS 740 file system into the subdirectory <session-id> in the directory npc_mount in the Host OS 730 file system. The SMB File Access 728 mechanism follows the industry standard SMB protocol and has two actors, one in the Host OS 730 and one in the Guest OS 740. All setup protocol handshake and exchange of credential information is performed over a secure networking channel created by the two actors, using the Loopback Networking 726.
868: The SMB File Access 728 actor in the Guest OS 740 looks specifically for the existence of the 128 bit token in the mounto request authentication protocol. If present, the SMB File Access 728 calls NativeX Management (2) 716 to match the presented credentials and token against a stored session control object; otherwise it calls the previously existing Guest OS 740 authentication mechanism.
869: If the credentials and token match the stored credentials and token, the authorization request succeeds. Back in 868, the SMB File Access 728 uses the credentials to finish the mount of the Guest OS 740 file system. For every future request from the Native app process 1 714 (or any other Native app process) via path 716 to any user files 718, SMB File Access 728 uses the supplied credentials to authorize the file access. Thus, the access from the Native app process 1 714, initiated by appl 2 702 uses the same credentials as appl 2 702 uses to access user files 718 from within the Guest OS 740 file system. For the NativeX case, the SMB File Access 728 actor in the Guest OS 740 file system creates and populates these file directories in the Guest OS 740 file system for use by the Native app process 1 714: bin, dev, etc, home, lib64, proc, run, sbin, svu, tmp, usr, and var, along with a special directory named GUESTOS to access all files in the Guest OS 740 file system (subject to matching the authorization criteria).
870: Return OK or fail status to the NativeX Daemon 706.
872: If OK status, the file hierarchy is similar to that shown in FIG. 9. The entire hierarchy is viewable by a privileged user in the Host OS 730, with some file and directory branches local to the Host OS 730 file system and other branches remote in the Guest OS 740 file system.
The NativeX Daemon 706 returns an OK or fail status to NativeX Management (1) 716.
NativeX Management (1) 716 stores the socket information into the process control object 852.
If OK status, the NativeX Daemon 706 launches the chosen process as described above. It uses Host OS 730 services to launch the new process (process tree) and to associate the new process with the specific UID/GID pair and with the secure sandbox 708. Then it calls the Host OS 730 service chroot( ) to associate the process with the session directory e.g., session 1023. The NativeX Daemon 706 also calls the Host OS 730 service chmodo to alter the permissions for the session directory e.g., session 1023 to user: read, write, execute; group: read, write, execute, other: none, none, none. Because each process associated with a session share the same UID/GID pair, all the processes can read and write files and directories in the session directory, under the same credentials following the rules of the Host OS 730 file system and the Guest OS 740 file system.

The chroot( ) service requires privileged (super user) access in the Host OS 730. Privileged access is disallowed for Native app processes according to the secure sandbox constraints. “A chroot is an operation that changes the apparent root directory for the current running process and their children. A program that is run in such a modified environment cannot access files and commands outside that environmental directory tree. This modified environment is called a chroot jail.” from https://wiki.archlinux.org/index.php/Chroot

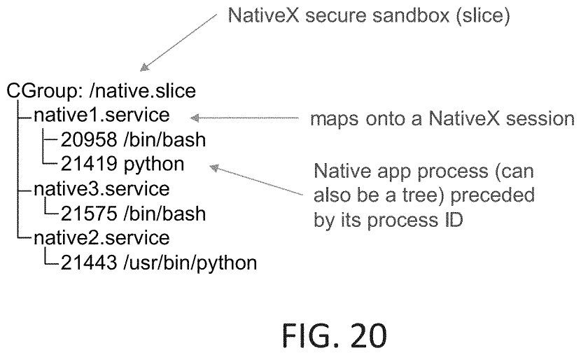

FIG. 20 illustrates an example of the process hierarchy created in the Host OS 730 after several Native app processes have been initiated by NativeX.

The NativeX Daemon 706 creates a pair of execution threads for each Native app process and redirects STDIN and STDOUT to these processes. When the initiating appl 2 702 makes a NativeX write request (see Programmatic API description below), NativeX Management 716 uses the socket in the process control object to pass the write packet's information to the STDIN redirector thread. When the initiating appl 2 702 makes a NativeX read request (see Programmatic API description below), NativeX Management 716 uses the socket in the process control object to retrieve the information from the STDOUT redirector thread.

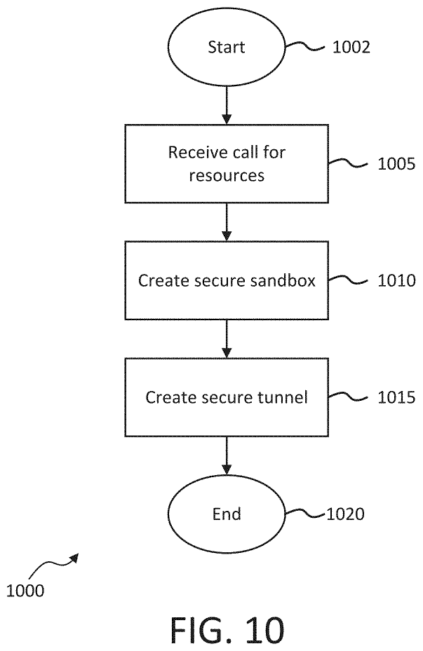

Referring to FIG. 10, a method of allowing a Guest OS to control and manage resources is illustrated. The method beings at 1002. At 1005, the Host OS receives a call for resources from a Guest OS. At 1010, the Host OS creates a secure sandbox for the Guest OS. At 1015, the Host OS creates a secure tunnel for communication between the Guest OS and the secure sandbox. The method ends at 1020.

In the hybrid execution environment, sometimes a user at a terminal logged into the Guest OS 740 in command mode wants to make use of a corresponding command environment in the Host OS 730 such as bash in Linux or cmd in Windows. In the NativeX case, the terminal protocol to the Guest OS 740 is a block-mode protocol such as IBM 3270 terminal protocol or the UNISYS® UTS terminal protocol. The corresponding command environment in the Host OS 730 uses a streaming protocol such as Xterm. A system requirement is that the bash or other command protocol must be able to be used in the NativeX environment with no modifications.

To provide a seamless interaction between a user at a terminal in the Guest OS 740, and a command session in the Host OS 730, a protocol translation mechanism was created. It leverages the secure sandbox creation mechanism and certificate mechanism to create a secure path between the terminal user, the command session on the Guest OS 740 and the command process on the Host OS 730. NativeX provides these utilities with their corresponding pre-configured Native process code and required ecosystems.
@bash The UNIX/Linux interactive and scripting utility
@git The widely used version control system
@grep The file contents searching utility
@java The Java portable programming environment
@python The Python programming environment
@svn An instance of the Subversion code management system
@javac The Java programming language compiler

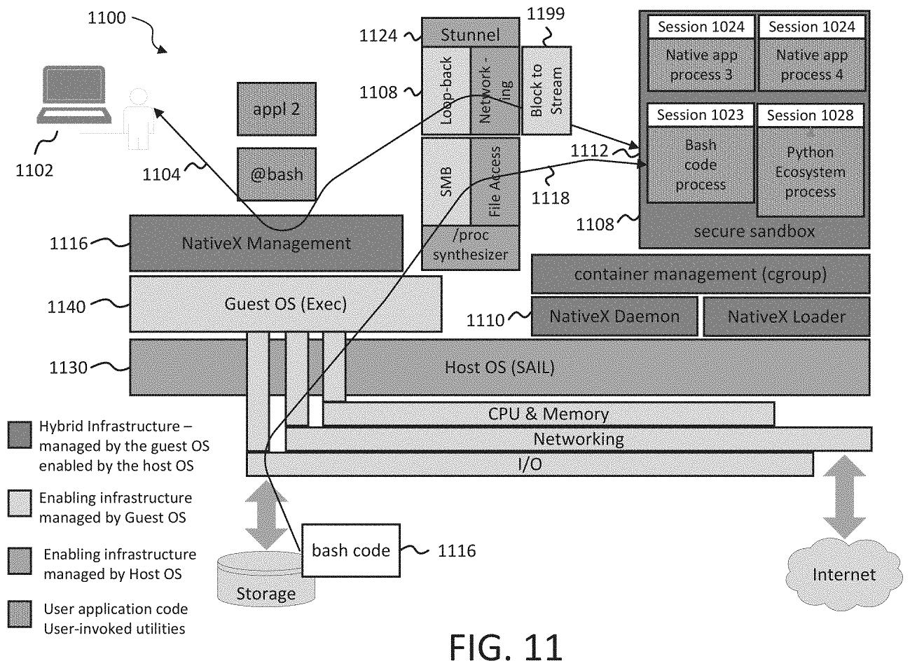

Referring to FIG. 11, the mechanism 1100 for @bash command is shown. The other utilities use the NativeX infrastructure in a similar way. The user at terminal device 1102 logs onto the Guest OS 1140 using existing mechanisms to initiate a command session. The terminal uses a block-mode protocol such as IBM 3270 or Unisys UTS. In the command session, the user invokes the bash interceptor 1104 which invokes the NativeX management 1116 to cause the NativeX Daemon 1110 to load the bash code 1116 into the secure sandbox 1108 using path 1118, as bash code process 1112, and begin its execution. The Block to Stream mechanism 1199 converts between the block-mode protocol and the stream protocol. Information sent from the terminal 1102 to the bash code process 1112 is converted by Block to Stream 1199 from a block-mode protocol to a stream protocol. Information sent from the bash code process 1112 to the terminal 1002 is converted by Block to Stream 1199 from stream protocol to block-mode protocol. The information can include: cursor positioning, blinking or highlighting of text, enforcing protected and non-protected sections of the screen, text color, font, and size, tab stops and other field control character (FCC) controls and data.

In the hybrid execution environment, an application executing on the Guest OS 1140 may want to invoke a service to execute in the Host OS 1130 environment, calling it as if it were a local service such as a compiler runtime service. From the application's perspective, the called service must be able to be invoked as a procedure (no direct return value) or as a function (with a direct return value) and be able to pass parameters as by value or by reference or by whatever additional parameter mechanisms are supported by the application's programming language. The invocation mechanism must support all execution modalities in the Guest OS 1140, such as interactive (Demand), background (Batch), and transaction (TIP in the Unisys OS 2200 environment, COMS in the Unisys MCP environment, or CICS in the IBM Z/Series environment). In order to make a procedure call look local, NativeX provides a mechanism to call the service as a procedure or as a function:
Signature:
void* _native_start(native_args* args_packet)
where:
args_packet has the following format

| Field Name | Type | Description |
|---|---|---|
| version | unsigned short | The packet version number. |
| arg_count | unsigned short | The number of arguments present on |
| | | the native process command line. |
| modes | unsigned int | A bitmask used to specify one or |
| | | a combination of NPCLIB modes. |
| | | bit 1: NX_CALLER_IO |
| | | By default, NativeX creates |
| | | input and output handlers to |
| | | send and receive data to and from |
| | | the native process. Control is |
| | | returned to the caller |
| | | upon native process termination. |
| | | Set this mode to |
| | | cause _native_start( ) to |
| | | return immediately after the native |
| | | process is started. The caller can |
| | | then use the _native_read( ) and |
| | | _native_write( ) |
| | | APIs to send and receive data. |
| target | char* | The name of the native process to |
| | | start. |
| targ_args | char* * | The native process command line |
| | | arguments. |
| debug_file | void* | A pointer to an object returned by |
| | | fopen( ) or NULL. |
| | | Note: By passing a valid pointer, |
| | | the caller specifies that NPCLIB |
| | | functions will write trace |
| | | information to the file. |

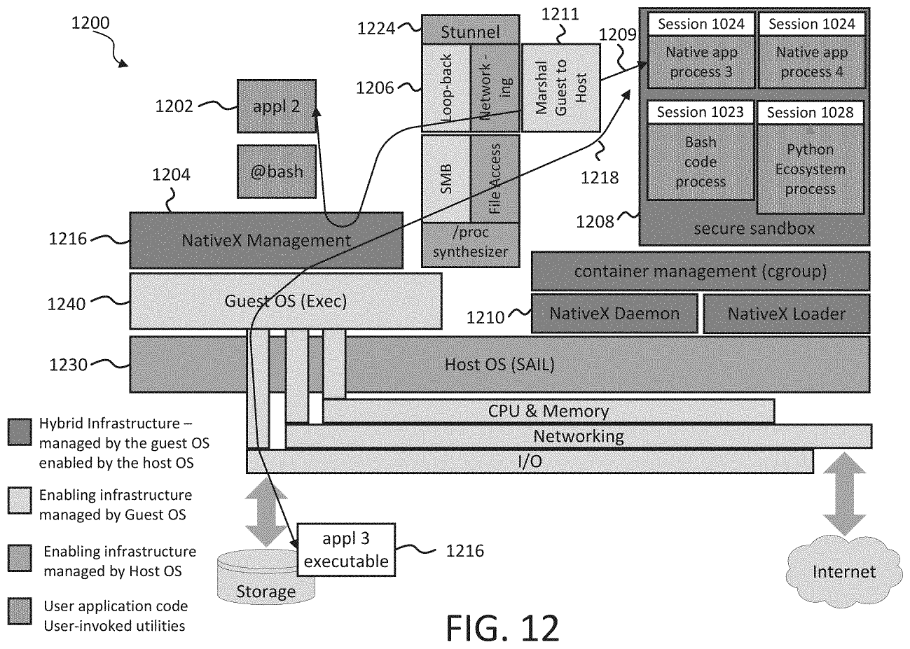

NativeX provides a binding for the _native_start wrapper for each Guest OS 1140 programming language such as C, COBOL, FORTRAN, and so on, such that the mechanism looks native to each application's chosen programming language. The _native_start mechanism leverages the secure sandbox creation mechanism and certificate mechanism to create a secure path between the Guest OS 1140 application caller and the service on the Host OS 1130. This is shown in FIG. 12. Use the _native_read( ) function to read data from a native process. The _native_read( ) function reads data from the native process started by the _native_start( ) call. If no data is available after thirty seconds, control is returned to the caller. Synopsis: int _native_read(void* native_handle, char* sir, int len, int mode); where: native_handle is a pointer to the native control area returned by native_start( ); str is a pointer to the buffer that receives the data; len is the number of bytes to be read; and mode is always 0.

Use the _native_write( ) function to write data to a native process. The _native_write( ) function writes data to the native process started by the _native_start( ) call. Synopsis: int _native_write(void* native_handle, char* str, int len, int mode); where: native_handle is a pointer to the native control area returned by native_start( ); str is a pointer to the buffer holding the data; len is the number of bytes to be written; and mode is always 0.

Use the _native_stop( ) function to terminate the execution of a NativeX process. The _native_stop( ) function stops the Native process started by the _native_start( ) function and deallocates the NativeX secure sandbox. Synopsis: int _native_stop(void* native_handle); where: native_handle is a pointer to the native control area returned by native_start( ).

A calling program appl 2 1202 wants to invoke Native process 3 1209 as a called procedure. The program appl 2 1202 uses the _native_start( ) mechanism in NativeX management 1216 to cause the NativeX Daemon 1210 to load the appl 3 executable 1216 into the secure sandbox 1208 using path 1218, as Native process 3 1209 and begin its execution. The Marshal Guest to Host mechanism 1211 transforms the call-by-value, call-by-reference and other parameter data and meta data from the calling program's environment in appl 2 1202 into a representation appropriate for the called service Native process 3. It also transforms the data values between the execution environments including: big endian to little endian integer representation, 9-bit ASCII to 16 bit UNICODE characters, IEEE format floating point numeric values to Intel floating point numeric values.

For any parameter or function return values passed by Native process 3 to appl 2, the Marshal Guest to Host 1211 does the transformations in the reverse direction, from the Native process 3 view to the appl 2 view. When the Native process 3 1209 completes execution and returns its result to appl 2 1202, the NativeX management 1216 signals the NativeX Daemon 1210 to terminate Native process 3 1209 and releases its resources. If the appl 2 1202 code terminates unexpectedly or is terminated by an operator action while the Native process 3 1209 is still executing, the Guest OS 1240 releases all resources held by appl 2 1202. The Guest OS 1240 signals the NativeX management 1216 which signals the NativeX Daemon 1210 to terminate the Native process 1209 and release its resources.

In the hybrid execution environment, sometimes a user wants to develop in a programming language not available in the Guest OS 1240. The programming language may require a specialized runtime environment or may require OS services or other environmental attributes available only in the Host OS 1230. In addition to the functional requirement for the programming language, the program development cycle must appear as if it were being executed in the Guest OS 1240 where other applications are being developed. Programming language runtime environments would reside in the “container” or sandbox along with the program being run. The runtime environment would be running in the Host OS 1230 rather than the Guest OS 1240.

NativeX provides pre-configured environments for executing, for example, the bash ecosystem (which includes for example the gcc compiler). A user can create a program source code using the mechanisms standard to the Guest OS 1240 and store the file in the Guest OS 1240 file system. The user then invokes, for example bash via the standard access mechanism in the Guest OS 1240. The NativeX Management intercepts the call and creates the bash ecosystem in the Host OS 1230. The user can then invoke, for example, gcc to compile the program source code into an executable.

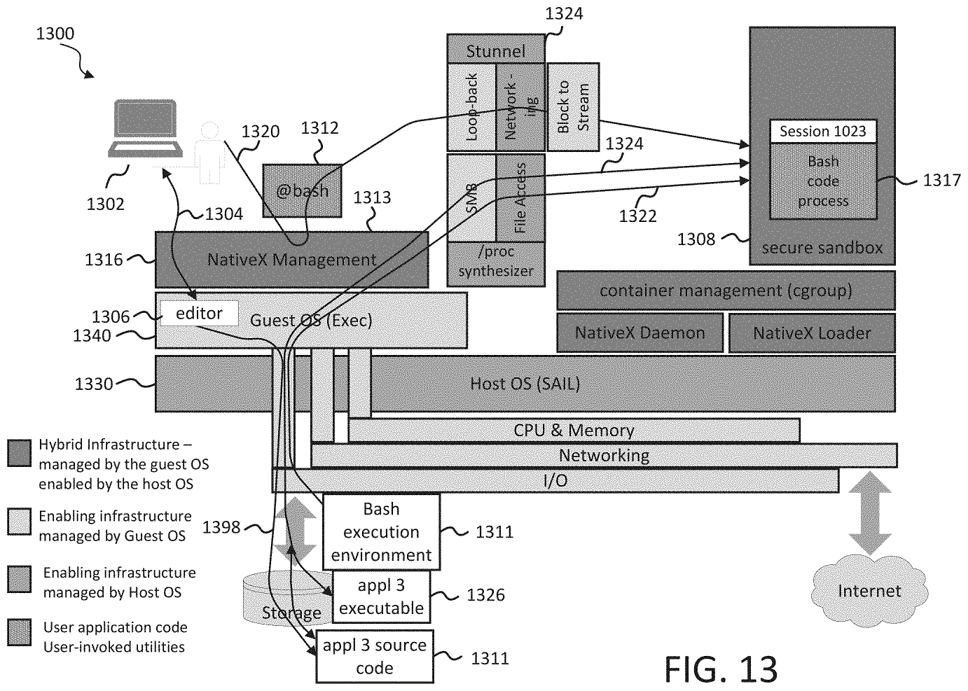

Referring to FIG. 13, a programmer at a workstation 1302 uses a pre-existing access mechanism 1304 to access an editor 1306 in the Guest OS 1340 environment. The programmer uses the editor to create source code in, for example, the python programming language and stores the program source code via pre-existing mechanism 1398 to the file appl 3 source code 1311. The programmer then uses a pre-existing mechanism to invoke bash 1312. The NativeX management 1316 uses the mechanisms described elsewhere to populate the secure sandbox 1308 with the bash execution environment 1311 as Bash code process 1317, and begin its execution.

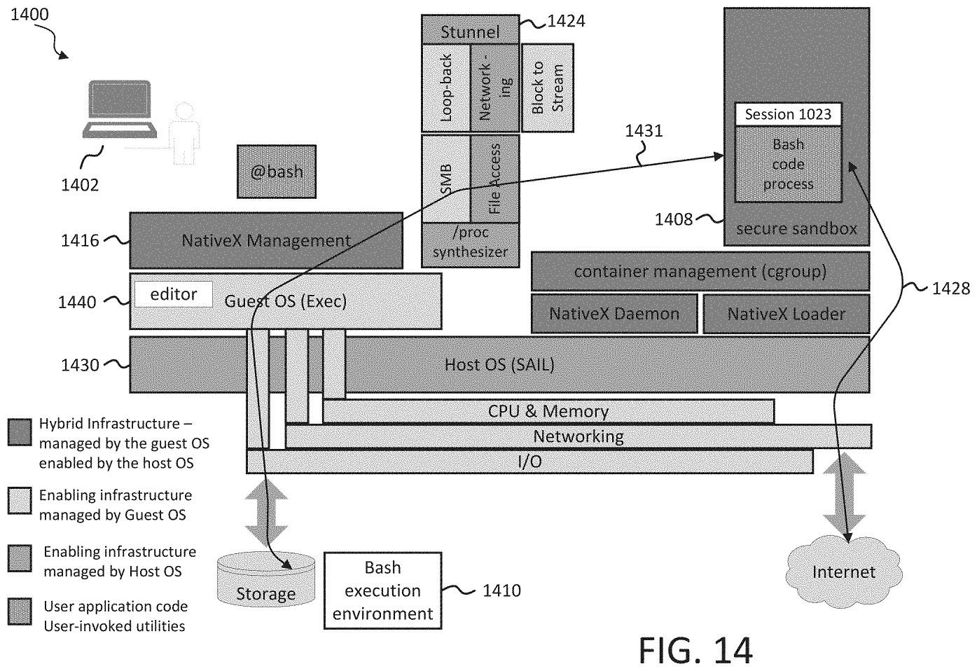

Once the bash program begins execution, the user 1302 can interact with bash using path 1320 for example to invoke the gcc compiler. The gcc compiler can read appl 3 source code 1311 using path 1324 and then write the appl 3 executable output file 1326 using the same path 1324. The appl 3 executable code can be executed by using terminal 1302 directly in bash or the user 1302 may use the @nxlink utility mechanism described below to create a guest-native executable. Once the bash program begins execution, it can access other files, networking, and services as shown in FIG. 14. Path 1428 provides network connectivity and security described elsewhere. Path 1431 provides file system access and security described elsewhere.

In the Guest OS 1340 environment, command streams, or command sequences, are a powerful and often-used mechanism for initiating program executions, providing program input, creating program input, pipelining utility calls together and so on. In one Host OS 1430 environment, these command sequences are called “Executive Control Language (ECL) scripts” or “add streams”. This invention provides the ability to combine and execute statements and from two discrete scripting languages (Python and ECL) into a single script.

NativeX provides the @pyadd utility to be able to use a python application to generate and execute an ECL script. It combines the capabilities described elsewhere for Utilities and Creating, Compiling, and Executing a program in a Hybrid environment described above. Signature is @pyadd python-code-file, where python-code-file is the name of the file containing the python script to generate the ECL script.

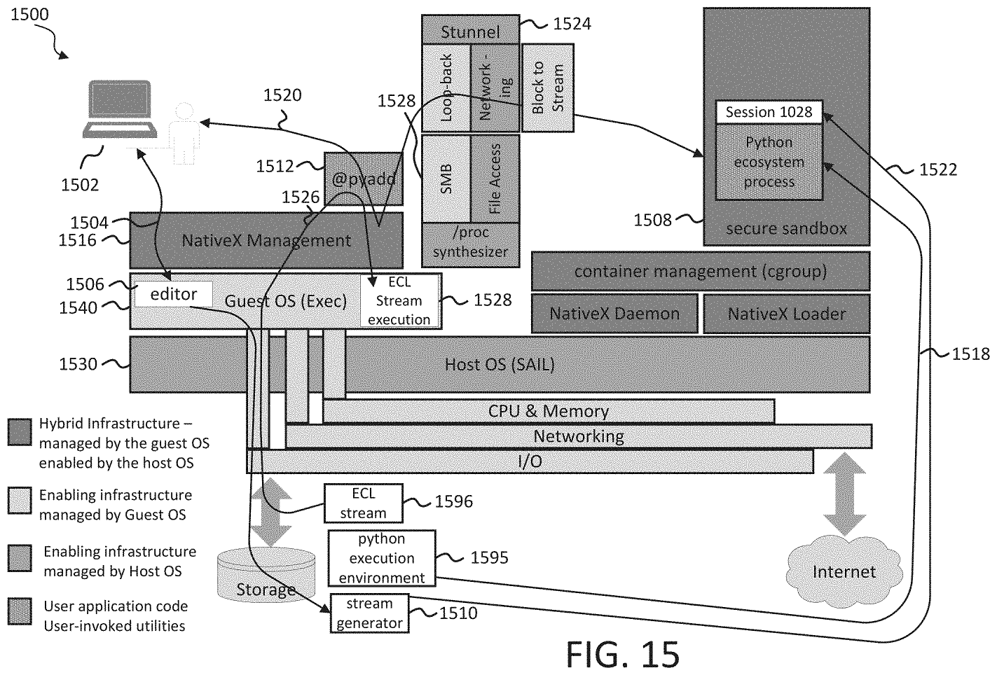

Referring to FIG. 15, a user 1502 creates the python code file as python source code 1510, using the previously existing mechanism described in FIGS. 13 and 14. The user then invokes the @pyadd utility 1512 from the Guest OS 1530. The python code can access file data and network services during its execution as described in FIGS. 13 and 14. The overall mechanism is shown in FIG. 15. During execution in the python ecosystem 1514, the stream generator python code 1510 creates output file ECL stream 1595. The @pyadd utility 1512 reads the file 1524 via pre-existing path 1526 and passes it to the Host OS ECL stream execution 1596.

The /proc directory in Unix-like operating systems, sometimes called the /proc file system, contains system information in the form of files. It contains what appear as zero-length files which the operating system fills in with information when the file is accessed.

The Host OS 1530 provides a variety of services to allow processes to query and modify system behavior via a synthetic file system under the directory /proc. Each time a process references an entry in this directory hierarchy, the Host OS intercepts the I/O request and satisfies it either via synthesizing the requested information (for input requests) or updating a system behavior parameter (for output requests).

In Unix-like systems, everything is managed as a file including devices of various kinds. Information about these virtual files is available through the /proc directory. In this solution, the Guest OS 1540 rather than the Host OS 1530 determines the user's view of the /proc filesystem on the Host OS 1530. In NativeX secure sandbox execution, the secure sandboxes have their view of the system restricted in many ways, including file system access and networking access to name two. NativeX secure sandboxes also have their view of /proc restricted. To provide a compatible execution environment for standard off-the-shelf programs, utilities, and ecosystems which can execute in the NativeX secure sandbox 1508 in the Host OS 1530, NativeX provides access to the /proc directory in the Host OS 1530 file system only if the process executing in the NativeX secure sandbox 1508 is asking for information about itself; and the process executing in the NativeX secure sandbox 1508 is asking for information on execution threads running with the same credentials as the requestor. Such requests will only succeed if the requesting process has sufficient privilege. In the NativeX environment, the SMB File Access 1528 mechanism maintains a directory named /proc, but it provides only a subset of the readable entries from the system /proc hierarchy for convenience of each Native process.

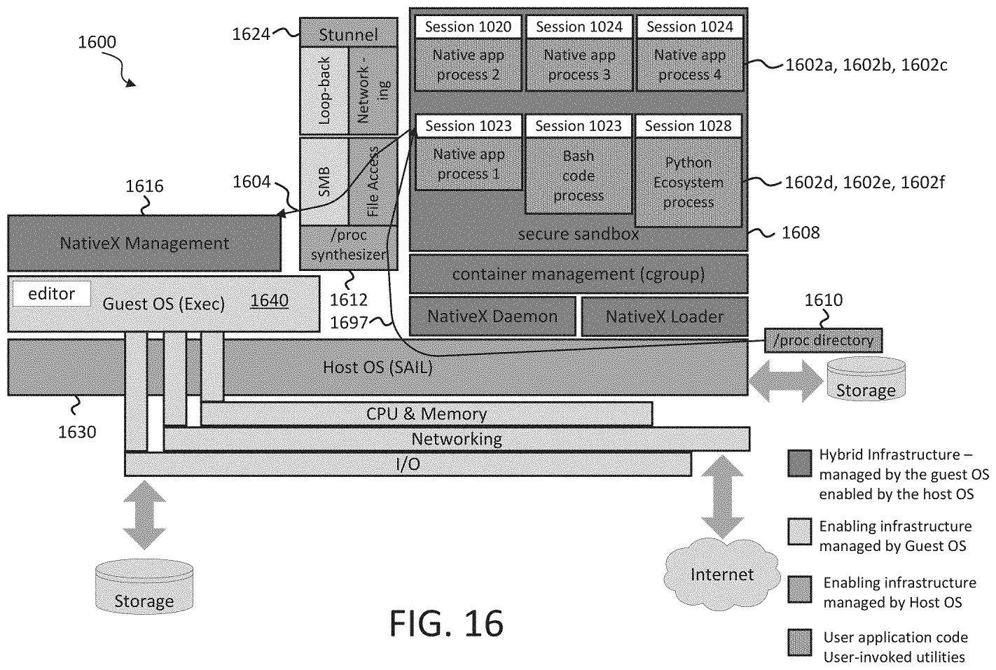

Referring to FIG. 16, a process 1602a, 1602b, 1602c, 1602d, 1602e, 1602f makes a request to access the /proc directory 1610 e.g., using the cd command. NativeX management 1616 analyzes the request to see if it meets the criteria outlined above. If so, it creates path 1697 so the process 1602a-f may read the /proc directory entries. The Host OS 1630 de-virtualizes the directory's data and returns the requested information to the process 1602a-f through the /proc synthesizer 1612 which removes, replaces, or adds information as appropriate.

To make the NativeX capability most useful in the Guest OS 1640 environment requires a mechanism such that NativeX processes can be called using the standard program or utility calling sequence provided by the Guest OS 1640. NativeX provides the @nxlink utility to wrapper any Native process or program and make it callable by the standard Guest OS 1640 calling sequence. The Native process can be written in any language and use any ecosystem supported by NativeX such as C, C++, python, or Java. It can also include execution of bash and any utility supported by bash. Signature is @NXLINK [−a] [−d] [−i p] [−l] [−o output_zoom] nx-program [static_options] [static_args . . . ] where:

| Option | Description |
|---|---|
| * -a | Specifies the use of ANSI rather than |
| | UTS terminal handling in nx-program. |
| * -d | Specifies the use of debug mode when |
| | executing nx-program. |
| * -i | Specifies an executable program to |
| | include entirely in the output ZOOM, |
| | rather than just including a CIFS |
| | file specification of the program. |
| * -o | Specifies the path name for the |
| | generated ZOOM file. If a “.abs” |
| | name extension is not given, one is |
| | appended. If the -o option is |
| | omitted, or just a directory is |
| | provided, the ZOOM name is taken |
| | from the nx-program or the name of |
| | the program specified by |
| | the -i parameter. |
| *nx-program | Use this program as the primary |
| | NativeX Execution environment |
| | processor for beginning execution of |
| | the generated ZOOM. If the specified |
| | program name is not found in the |
| | current directory, nor in any of the |
| | default search path directories |
| | (/usr/local/bin:/usr/bin:/bin), the |
| | path to the program must be included |
| | in this parameter. |
| *static_options | Option arguments (that is, with a “-” |
| | prefix) to pass to the nx-program |
| | each time the ZOOM is run. When the |
| | generated ZOOM is executed in |
| | batch or demand, this option, and the |
| | static_args, are passed directly to |
| | nx-program when the generated ZOOM |
| | is executed. |
| *static_args | The remaining arguments that is passed |
| | to nx-program each time the ZOOM |
| | is executed. |

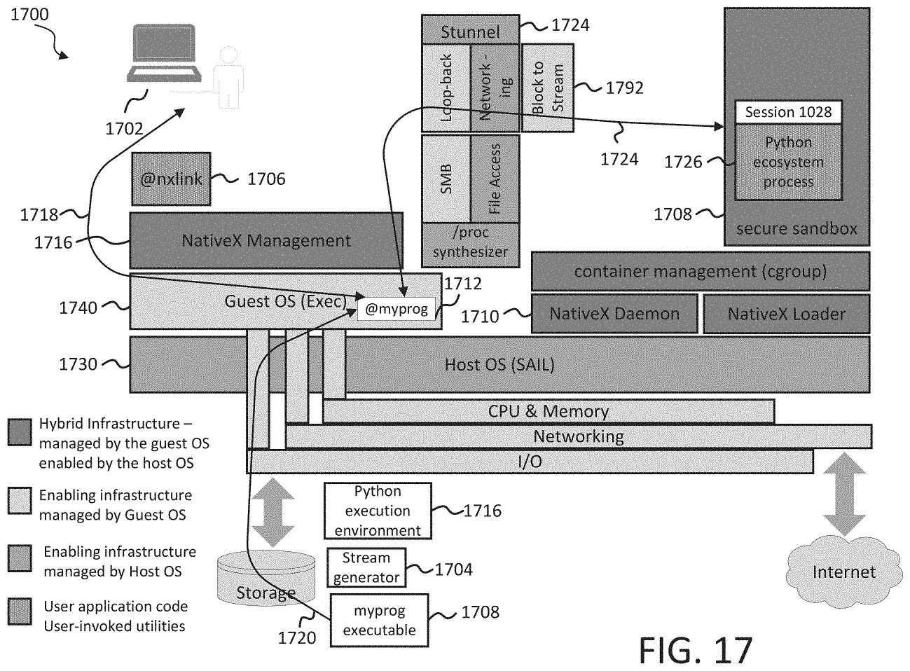

The use of @nxlink is shown for a python program in FIG. 17. A user 1702 uses pre-existing mechanisms to create the program source 1704. Next, the user invokes the @nxlink utility 1706, specifying the desired parameters: @nxlink −a −o myprog python appl4.py, which causes nxlink to construct the myprog executable 1708 containing a call to the python ecosystem 1714 passing the python program appl4.py 1704. The −a option causes Block to Stream processing 1792 to use Xterm rather than block terminal protocol.

To execute the program, user 1702 invokes the @myprog program 1712 using the pre-existing mechanism through path 1718. The invocation loads the program executable 1708 using the pre-existing mechanism through path 1720. When the program @myprog 1712 begins execution, it uses the NativeX management 1716 to cause the NativeX Daemon 1710 to load the python ecosystem 1716 and the python code appl4.py 1704 into the secure sandbox 1708 as Python ecosystem process 1726, and begin its execution. The @myprog program 1712 communicates with the python ecosystem using path 1724.

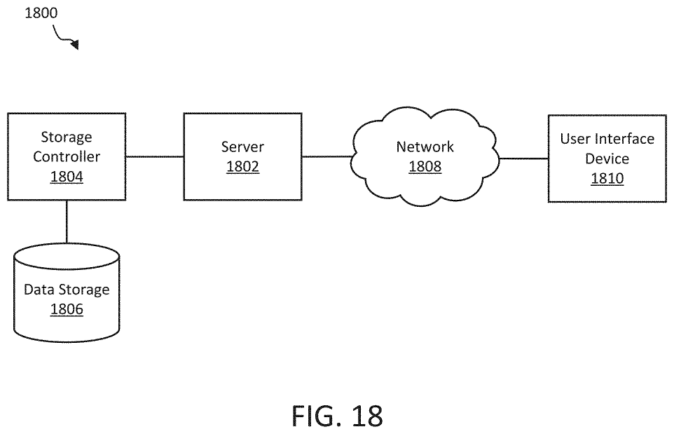

FIG. 18 illustrates one embodiment of a system 1800 for a computing system that may include a server 1802, a data storage device 1806, a network 1808, and a user interface device 1810. The server 1802 may be a dedicated server or one server in a cloud computing system. The server 1802 may also be a hypervisor-based system executing one or more guest partitions. The user interface device 1810 may be, for example, a mobile device operated by a tenant administrator. In a further embodiment, the system 1800 may include a storage controller 1804, or storage server configured to manage data communications between the data storage device 1806 and the server 1802 or other components in communication with the network 1808. In an alternative embodiment, the storage controller 1804 may be coupled to the network 1808.

In one embodiment, the user interface device 1810 is referred to broadly and is intended to encompass a suitable processor-based device such as a desktop computer, a laptop computer, a personal digital assistant (PDA) or tablet computer, a smartphone or other a mobile communication device having access to the network 1808. The user interface device 1810 may be used to access a web service executing on the server 1802. When the device 1810 is a mobile device, sensors (not shown), such as a camera or accelerometer, may be embedded in the device 1810. When the device 1810 is a desktop computer the sensors may be embedded in an attachment (not shown) to the device 1810. In a further embodiment, the user interface device 1810 may access the Internet or other wide area or local area network to access a web application or web service hosted by the server 1802 and provide a user interface for enabling a user to enter or receive information.

The network 1808 may facilitate communications of data, such as dynamic license request messages, between the server 1802 and the user interface device 1810. The network 1808 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 1810 accesses the server 1802 through an intermediate sever (not shown). For example, in a cloud application the user interface device 1810 may access an application server. The application server may fulfill requests from the user interface device 1810 by accessing a database management system (DBMS). In this embodiment, the user interface device 1810 may be a computer or phone executing a Java application making requests to a JBOSS server executing on a Linux server, which fulfills the requests by accessing a relational database management system (RDMS) on a mainframe server.

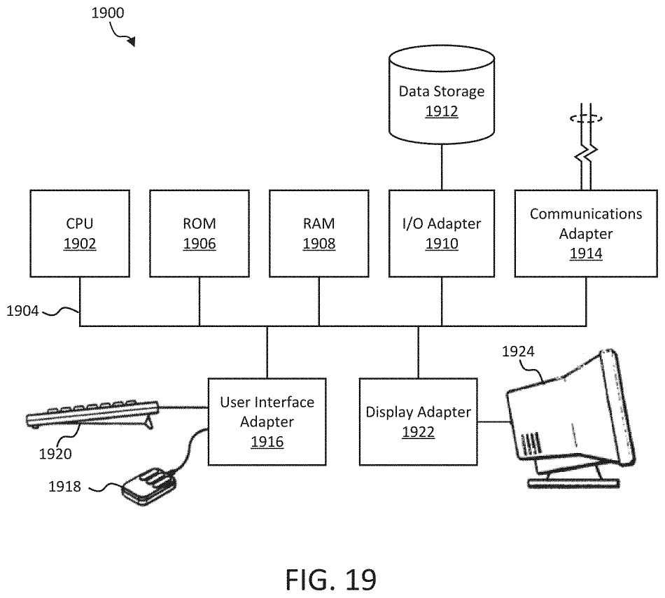

FIG. 19 illustrates a computer system 1900 adapted according to certain embodiments of the server 1802 and/or the user interface device 1810 of FIG. 18. The central processing unit (“CPU”) 1902 is coupled to the system bus 1904. The CPU 1902 may be a general purpose CPU or microprocessor, graphics processing unit (“GPU”), and/or microcontroller. The present embodiments are not restricted by the architecture of the CPU 1902 so long as the CPU 1902, whether directly or indirectly, supports the operations as described herein. The CPU 1902 may execute the various logical instructions according to the present embodiments.

The computer system 1900 may also include random access memory (RAM) 1908, which may be synchronous RAM (SRAM), dynamic RAM (DRAM), synchronous dynamic RAM (SDRAM), or the like. The computer system 1900 may utilize RAM 1908 to store the various data structures used by a software application. The computer system 1900 may also include read only memory (ROM) 1906 which may be PROM, EPROM, EEPROM, optical storage, or the like. The ROM may store configuration information for booting the computer system 1900. The RAM 1908 and the ROM 1906 hold user and system data, and both the RAM 1908 and the ROM 1906 may be randomly accessed.

The computer system 1900 may also include an I/O adapter 1910, a communications adapter 1914, a user interface adapter 1916, and a display adapter 1922. The I/O adapter 1910 and/or the user interface adapter 1916 may, in certain embodiments, enable a user to interact with the computer system 1900. In a further embodiment, the display adapter 1922 may display a graphical user interface (GUI) associated with a software or web-based application on a display device 1924, such as a monitor or touch screen.

The I/O adapter 1910 may couple one or more storage devices 1912, such as one or more of a hard drive, a solid state storage device, a flash drive, a compact disc (CD) drive, a floppy disk drive, and a tape drive, to the computer system 1900. According to one embodiment, the data storage 1912 may be a separate server coupled to the computer system 1900 through a network connection to the I/O adapter 1910. The communications adapter 1914 may be adapted to couple the computer system 1900 to the network 1808, which may be one or more of a LAN, WAN, and/or the Internet. The user interface adapter 1916 couples user input devices, such as a keyboard 1920, a pointing device 1918, and/or a touch screen (not shown) to the computer system 1900. The display adapter 1922 may be driven by the CPU 1902 to control the display on the display device 1924. Any of the devices 1902-1922 may be physical and/or logical.

The applications of the present disclosure are not limited to the architecture of computer system 1900. Rather the computer system 1900 is provided as an example of one type of computing device that may be adapted to perform the functions of the server 1802 and/or the user interface device 1810. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 1800 may be virtualized for access by multiple users and/or applications.

If implemented in firmware and/or software, the functions described above may be stored as one or more instructions or code on a computer-readable medium. Examples include non-volatile computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method of allowing command sessions in a guest operating system, the method comprising:
receiving, by a host operating system, a request to invoke a command session by a guest operating system;
receiving, by the host operating system, a request to invoke a bash interceptor; and
loading bash code into a secure sandbox on the host operating system.

2. The method of claim 1, wherein receiving a request to invoke a bash interceptor is in a first protocol.

3. The method of claim 2, wherein loading bash code includes loading bash code into a secure sandbox having a second protocol.

4. The method of claim 3, further comprising converting the first protocol received from the guest operating system to the second protocol for execution in the secure sandbox.

5. The method of claim 4, wherein converting includes converting a block protocol received from the guest operating system to a stream protocol for execution in the secure sandbox.

6. The method of claim 4, further comprising converting the second protocol to the first protocol for return to the guest operating system.

7. The method of claim 6, further comprising converting form a stream protocol to a block protocol information to be returned to the guest operating system.

8. The method of claim 7, wherein the information to be returned can include cursor positioning, blinking or highlighting text, enforcing protected and non-protected sections of the screen, text color, font, font size, tab stops and other field control character controls and data.

9. The method of claim 1, wherein receiving a request to invoke a command session includes receiving a request to invoke a command session by a guest operating system through a secure tunnel.

10. The method of claim 9, wherein receiving a request to invoke a command session includes receiving a request to invoke a command session by a guest operating system through a secure tunnel having loop back networking.

11. A computer program product for allowing command sessions in a guest operating system, the method comprising:
a non-transitory computer-readable medium comprising a set of instructions that when executed by a programmable computing device causes the computing device to implement a method for configuring a set of network devices, the method comprising:
receiving, by a host operating system, a request to invoke a command session by a guest operating system;
receiving, by the host operating system, a request to invoke a bash interceptor; and
loading bash code into a secure sandbox on the host operating system.

12. The computer program product of claim 11, wherein receiving a request to invoke a bash interceptor is in a first protocol.

13. The computer program product of claim 12, wherein loading bash code includes loading bash code into a secure sandbox having a second protocol.

14. The computer program product of claim 13, further comprising converting the first protocol received from the guest operating system to the second protocol for execution in the secure sandbox.

15. The computer program product of claim 14, wherein converting includes converting a block protocol received from the guest operating system to a stream protocol for execution in the secure sandbox.

16. The computer program product of claim 14, further comprising converting the second protocol to the first protocol for return to the guest operating system.

17. The computer program product of claim 16, further comprising converting form a stream protocol to a block protocol information to be returned to the guest operating system.

18. The computer program product of claim 17, wherein the information to be returned can include cursor positioning, blinking or highlighting text, enforcing protected and non-protected sections of the screen, text color, font, font size, tab stops and other field control character controls and data.

19. The computer program product of claim 11, wherein receiving a request to invoke a command session includes receiving a request to invoke a command session by a guest operating system through a secure tunnel.

20. The computer program product of claim 19, wherein receiving a request to invoke a command session includes receiving a request to invoke a command session by a guest operating system through a secure tunnel having loop back networking.
